(19) United States
(12) Patent Application Publication
(10) Pub. No.: US 2024/0278368 A1
(43) Pub. Date: Aug. 22, 2024

(54) AUTOMATIC TOOL MAGAZINE SYSTEM AND METHOD FOR AUTOMATIC TOOL CHANGES USING STANDARD SPINDLES FOR CNC MILLS AND ROUTERS

(71) Applicant: GREILICK INDUSTRIES LLC, Maple City, MI (US)

(72) Inventor: Donald Edwin Greilick, Maple City, MI (US)

(73) Assignee: GREILICK INDUSTRIES LLC, Maple City, MI (US)

(21) Appl. No.: 18/581,306

(22) Filed: Feb. 19, 2024

Related U.S. Application Data
(60) Provisional application No. 63/576,458, filed on Feb. 19, 2023.

(51) Int. Cl. B23Q 3/157; B23Q 3/155

(52) U.S. Cl. CPC B23Q 3/15706; B23Q 3/15526; B23Q 3/15536; B23Q 3/15553; B23Q 2003/1553

(57) ABSTRACT

A rapid change automatic tool change (ATC) magazine comprises a base having an exterior side and an interior side opposite the exterior side, and one or more passageways extending between the exterior side and the interior side, each of the one or more passageways defined by an interior opening and an exterior opening, a spring disposed within each of the one or more passageways of the base, a socket disposed within each of the one or more passageways, the socket having a body, an exterior surface, and an interior surface opposite the exterior surface, and a retaining cap having an upper side and a lower side opposite the upper side wherein the retaining cap includes one or more channels extending through the upper side and the lower side, each of the one or more channels being defined by an upper opening and a lower opening, wherein each of the one or more channels aligns with one of the one or more passageways.

### CROSS REFERENCE TO RELATED APPLICATIONS

This U.S. patent application claims priority under 35 U.S.C. § 119(e) to U.S. Provisional Application 63/576,458, filed on Feb. 19, 2023. The disclosure of this prior application is considered part of the disclosure of this application and is hereby incorporated by reference in its entirety.

### TECHNICAL FIELD

The present disclosure relates generally to automatic tool changers for computer numerical controllers (CNCs), and more specifically, to an automatic tool changer that enables standard CNC spindles, i.e., CNC spindles that require manual loading and unloading of tools/cutters, to perform automatic tool change (ATC) operations.

### BACKGROUND INFORMATION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

CNC mills and routers (collectively referred to herein as CNC machines), allow operators/users to install and load and unload various types of tools bits (also referred to herein as cutters) onto the spindles of CNC machines. Each cutter is specific to the type of job that a user desires the CNC machine to perform, such as milling, drilling, boring, etc., into a variety of materials, to create a new part or modify an existing part. Each cutter is inserted into a spring collet which in turn is disposed into a clamping nut (referred to herein as the tool assembly). The clamping nut includes threads that correspond to and can be installed on the threads of a standard spindle for attachment purposes. Users perform loading and unloading of cutters through a hand-supplied force to align the threads of the clamping nut to the corresponding threads on the spindle and begin the threading process. A hand wrench is then employed to supply a force sufficient to securely attach the clamping nut, and thus by extension, the cutter to the CNC spindle. This can be a time-consuming and disruptive process, especially during workflows that require frequent tool changes.

It has long been sought for a lower cost, less complex system and method for automatically changing tools on CNC machines that employ standard spindles. Many solutions have been attempted and most consist of an apparatus to hold the spindle shaft while another apparatus using some type of motor to rotate the tool assembly into the spindle shaft. These previous attempts are actually much slower than using hand wrenches, thus, there is a need in the art for an effective automatic tool change solution.

Other attempts include a tool assembly that is held in position by a hexagonal socket consisting of a hexagonal interior shape which can hold the clamping nut against rotation. This hexagonal socket is additionally preloaded with three springs around the outer circumference of the socket forcing it up towards the opposite direction the spindle will travel to engage it. Additionally, the hexagonal socket is retained within a channel by a retaining cap having a passageway for the tool assembly. The spindle is brought down to a position centered on the assembly depressing the nut slightly and the spindle is energized for clockwise rotation. This allows the spindle and clamping nut to be threaded together, completing the process of loading the tool assembly. Because the spindle is under load by depressing the clamping nut before it becomes energized, no appreciable rotational inertia is achieved by the mass of the spindle. Most 2.2 KW spindles have an upper torque limit of approximately 0.88 Nm or 0.6491 ft. lbs. This falls far below the minimum torque value of 12 ft. lbs., which is required for proper operation of the tool assembly when installed on the spindle. Therefore, when insufficiently torqued, the cutter in the tool assembly slips when trying to perform its intended purpose. This translates to a loose fit of the clamping nut and potentially dangerous operation of the cutter. This is a result of the standard spindle being unable to reach the required inertia by the mass of the rotating spindle before the clamping nut is captured and force is communicated. The CNC spindle cannot be energized when the clamping nut is external to a socket as attempting to insert a rotating clamping nut, e.g., at an RPM of at least 1500 rotations per minute (RPM), into a hexagonal socket could result in damaging the clamping nut, or the jamming of the clamping nut within the socket rendering it unable to be loaded again. Thus, there exists a need to provide ATC operations using non-ATC spindles that enables automatic attachment of clamping nuts which achieves a tightness of connection/fit that is substantially the same to that of a manual, wrenched-based installation of cutters.

### SUMMARY

One aspect of the disclosure provides a rapid change automatic tool change (ATC) magazine comprising a base having an exterior side and an interior side opposite the exterior side, and one or more passageways extending between the exterior side and the interior side, each of the one or more passageways defined by an interior opening and an exterior opening, a spring disposed within each of the one or more passageways of the base, the spring having a distal end facing the exterior opening of each of the one or more passageways, and a proximal end facing the interior opening of each of the one or more passageways, a socket disposed within each of the one or more passageways, the socket having a body, an exterior surface, and an interior surface opposite the exterior surface with two or more engagement members disposed on the interior surface, wherein the exterior surface circumscribes the interior surface, and a retaining cap having an upper side and a lower side opposite the upper side, wherein the retaining cap is fixed to the interior side of the base, and wherein the retaining cap includes one or more channels extending through the upper side and the lower side, each of the one or more channels being defined by an upper opening and a lower opening, wherein each of the one or more channels aligns with one of the one or more passageways.

Implementations of the disclosure may include one or more of the following optional features. In some implementations, each one or more passageways of the base includes a socket shelf and a spring shelf. A passageway wall between the interior side of the base and the socket shelf may be shaped to correspond to the shape of the exterior surface of the socket. A height of the passageway wall between the interior side of the base and the socket shelf may be greater than a depth of the socket.

The socket may include a conduit, the conduit extending through the body of the socket and is defined by a top socket opening and a lower socket opening, wherein a portion of the conduit is circumscribed by the interior surface of the socket.

The socket may include a tool assembly shelf disposed within the conduit, extending perpendicularly from the interior surface of the socket, the tool assembly shelf comprising an interior side and an exterior side opposite the interior side, the exterior side positioned against the proximal end of the spring. The tool assembly shelf may define the lower socket opening.

The shape of the interior surface of the socket may be generally rounded.

The shape of the exterior surface of the socket may be non-rounded.

Each channel within the retaining cap may be generally rounded.

The shape of the interior surface of the socket may be non-hexagonal.

Another aspect of the disclosure provides a method for installing tools on non-automatic tool change spindles, the method comprising providing a rapid change automatic tool change (ATC) magazine, disposing a tool assembly, within a channel of a retaining cap of the rapid change ATC magazine, positioning a spindle of a CNC or similar machine above the rapid change ATC magazine, wherein the spindle is centered at an upper opening of the retaining cap, moving the spindle downward toward a clamping nut of the tool assembly disposed within a socket in the channel, rotating the spindle in a clockwise direction, engaging the spindle with the clamping nut, the clamping nut threading onto threads of the rotating spindle with a peripheral edge of the clamping nut engaging with two or more engagement members of the socket that protrude inward, continuing to rotate the spindle until engagement of the peripheral edge of the clamping nut and the two or more engagement members resists rotation to cause an abrupt rotational stop of the spindle, transmitting a torqueing force through the clamping nut that urges the clamping nut further onto the threads of the spindle, and moving the spindle upward and away from the ATC magazine with the tool assembly fully threaded onto the spindle.

Implementations of the disclosure may include one or more of the following optional features. In some implementations, the socket includes a body, an exterior surface, and an interior surface opposite the exterior surface with the two or more engagement members disposed on the interior surface, wherein the exterior surface circumscribes the interior surface. The shape of the interior surface of the socket may be non-hexagonal.

The two or more engagement members may be spherically shaped to prevent the clamping nut from jamming within the socket.

Another aspect of the disclosure provides a rapid change automatic tool change (ATC) magazine comprising a base having an exterior side and an interior side opposite the exterior side, and one or more passageways extending between the exterior side and the interior side, each of the one or more passageways defined by an interior opening and an exterior opening, a spring disposed within each of the one or more passageways of the base, a socket disposed within each of the one or more passageways, the socket having a body, an exterior surface, and an interior surface opposite the exterior surface, and a retaining cap having an upper side and a lower side opposite the upper side wherein the retaining cap includes one or more channels extending through the upper side and the lower side, each of the one or more channels being defined by an upper opening and a lower opening, wherein each of the one or more channels aligns with one of the one or more passageways.

Implementations of the disclosure may include one or more of the following optional features. In some implementations, the spring has a distal end facing the exterior opening of each of the one or more passageways and a proximal end facing the interior opening of each of the one or more passageways, wherein the exterior surface of the socket circumscribes the interior surface, wherein two or more engagement member are disposed on the interior surface, and wherein the retaining cap is fixed to the interior side of the base.

The two or more engagement members may be spherically shaped to prevent the clamping nut from jamming within the socket.

A height of the passageway wall between the interior side of the base and a socket shelf may be greater than a depth of the socket.

The shape of the interior surface of the socket may be non-hexagonal.

The details of one or more implementations of the disclosure are set forth in the accompanying drawings and description below. Other aspects, features, and advantages will be apparent from the description, drawings, and claims.

### BRIEF DESCRIPTION OF THE DRAWINGS

The drawings described herein are for illustrative purposes only of selected configurations and are not intended to limit the scope of the present disclosure.

FIG. 1A is a top, front-facing perspective view of an ATC magazine in accordance with principles of the present disclosure.

FIG. 1B is top, back-facing perspective view of the ATC magazine of FIG. 1A.

FIG. 2A is a front view of the ATC magazine of FIG. 1A.

FIG. 2B is a back view of the ATC magazine of FIG. 1A.

FIG. 3A is a top plan view of the ATC magazine of FIG. 1A.

FIG. 3B is a bottom plan view of the ATC magazine of FIG. 1A.

FIG. 4A is a first side view of the ATC magazine of FIG. 1A.

FIG. 4B is a second side view of the ATC magazine of FIG. 1A.

FIG. 5 is a cross-sectional view of the ATC magazine of FIG. 1 taken along line 5-5 in FIG. 3A.

FIG. 6 is a top perspective view of a base of the ATC magazine of FIG. 1A.

FIG. 7A is a top perspective view of a socket of the ATC magazine of FIG. 1A.

FIG. 7B is a bottom perspective view of the socket of FIG. 7A.

FIG. 8A is a perspective view of another exemplary socket of the ATC magazine of FIG. 1A.

FIG. 8B is a perspective view of another exemplary socket of the ATC magazine of FIG. 1A.

FIG. 9 is a cross-sectional view of the ATC magazine of FIG. 1A and a spindle in a first position.

FIG. 10 is a cross-sectional view of the ATC magazine of FIG. 1A and the spindle in a second position engaged with a tool of the ATC magazine.

FIG. 11 is a cross-sectional view of the ATC magazine of FIG. 1A and the spindle in a third position disengaged with the tool of the ATC magazine.

FIG. 12 is a cross-sectional view of a portion of the ATC magazine of FIG. 1A.

FIG. 13A is a top plan view of a socket receiving a clamping nut.

FIG. 13B is a top plan view of a socket receiving a UM type nut.

FIG. 14A is a side view of a tool assembly.

FIG. 14B is an exploded view of the tool assembly of FIG. 14A.

FIG. 15A is a perspective view of the ATC magazine of FIG. 1A and the spindle in a first position.

FIG. 15B is a perspective view of the ATC magazine of FIG. 1A and the spindle in a second position, engaging a tool.

FIG. 15C is a perspective view of the ATC magazine of FIG. 1A and the spindle in a third position disengaged from the tool.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising.” “including.” and “having.” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on.” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first.” “second.” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first.” “second,” and other numerical terms do not imply a sequence or order unless clearly indicated by the context. Thus, a first element, component, region, layer or section discussed below could be termed a second element, component, region, layer or section without departing from the teachings of the example configurations.

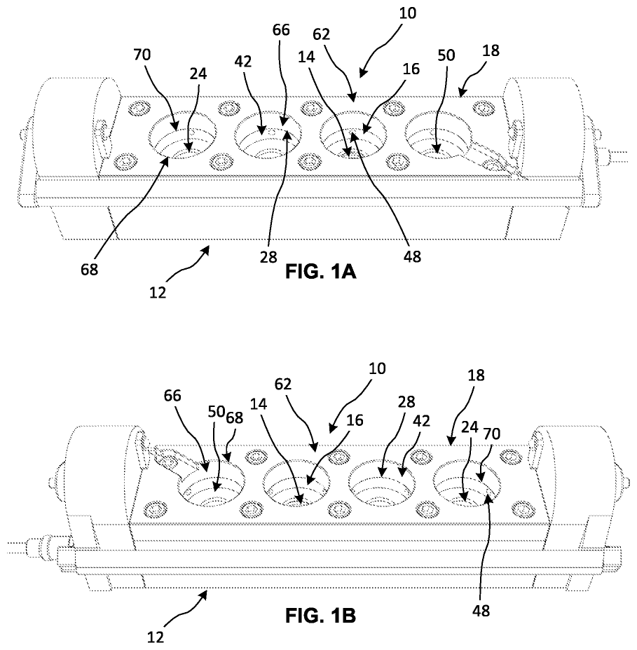

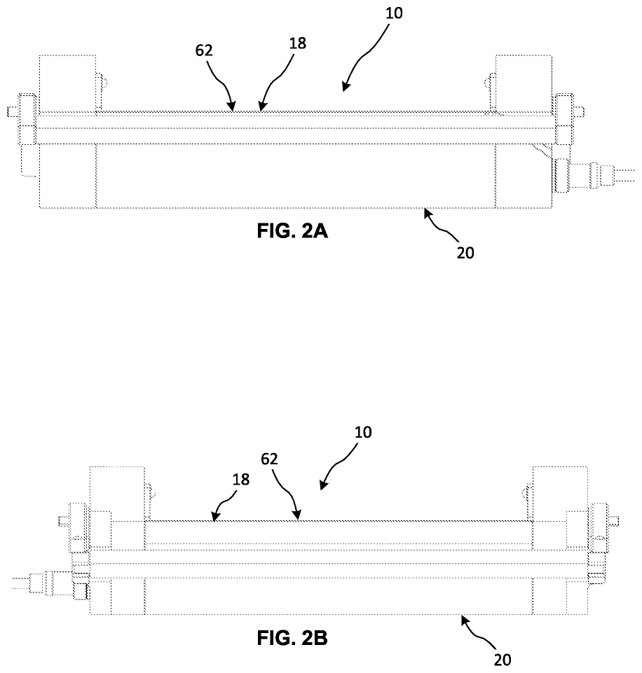

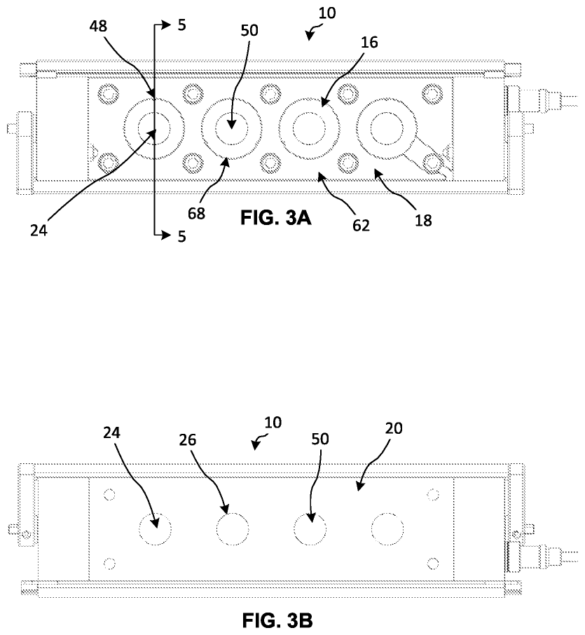

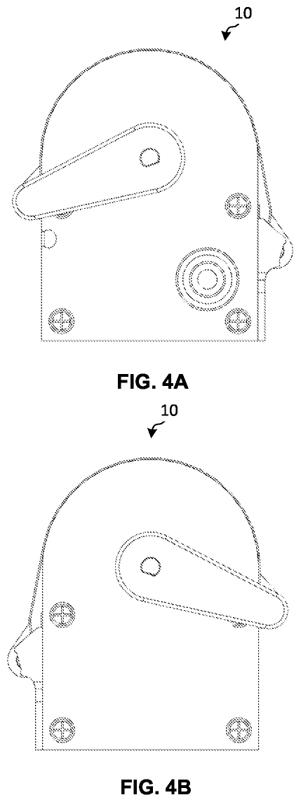

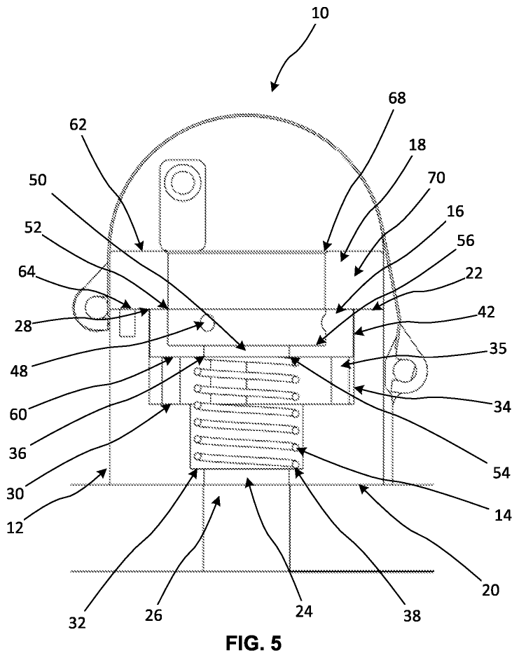

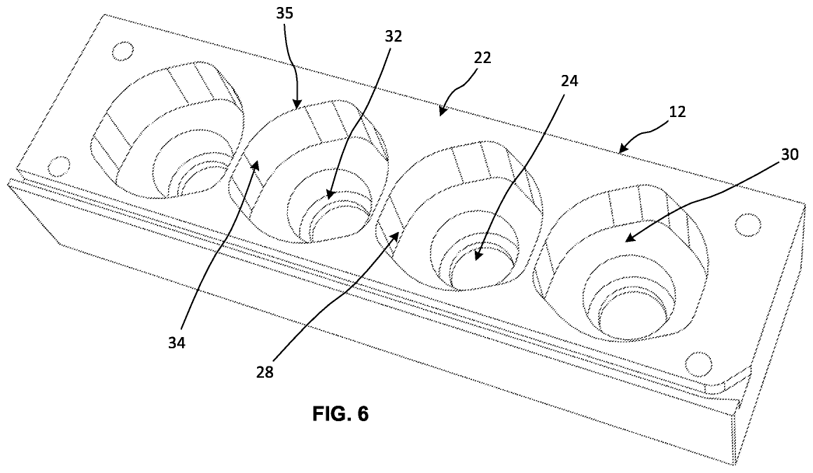

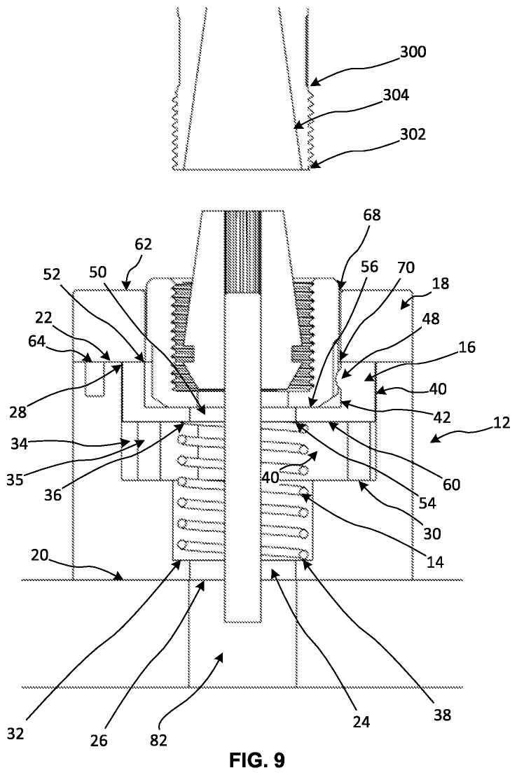

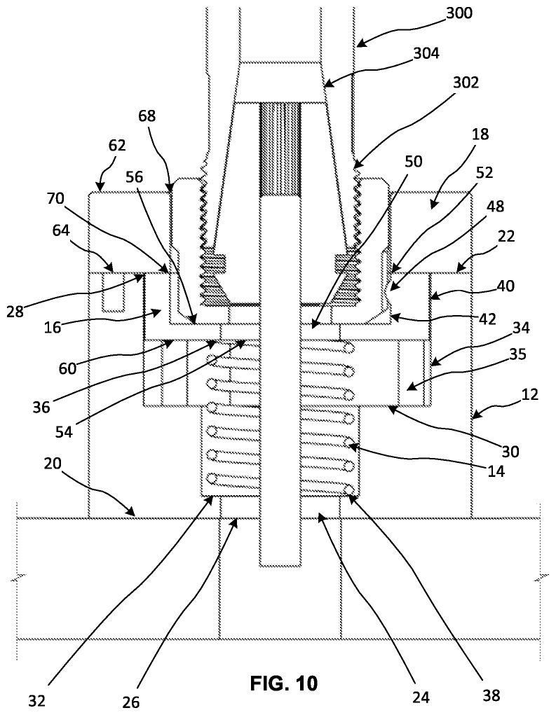

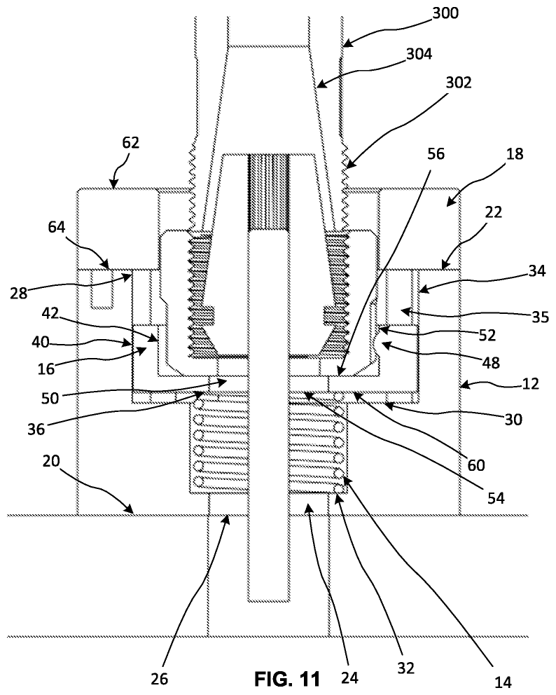

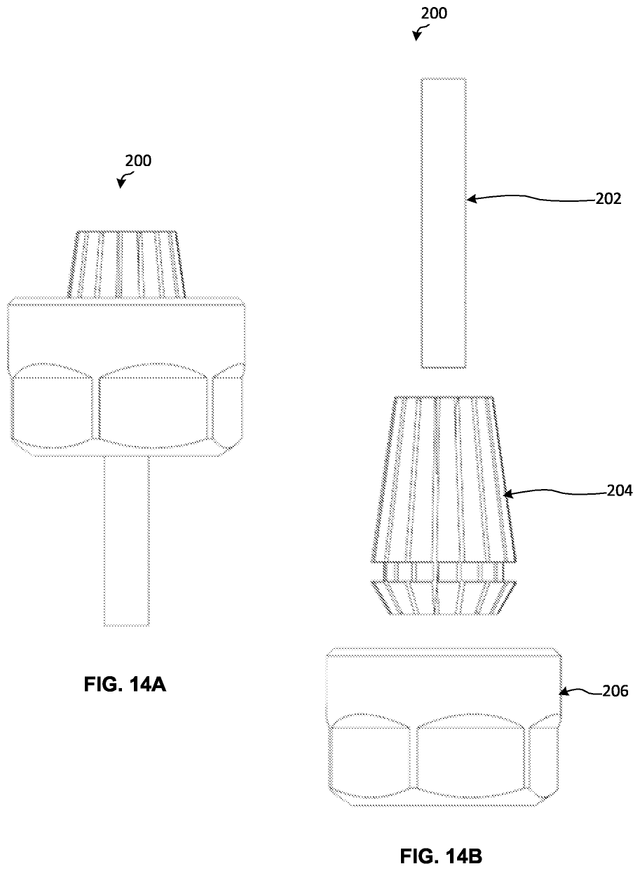

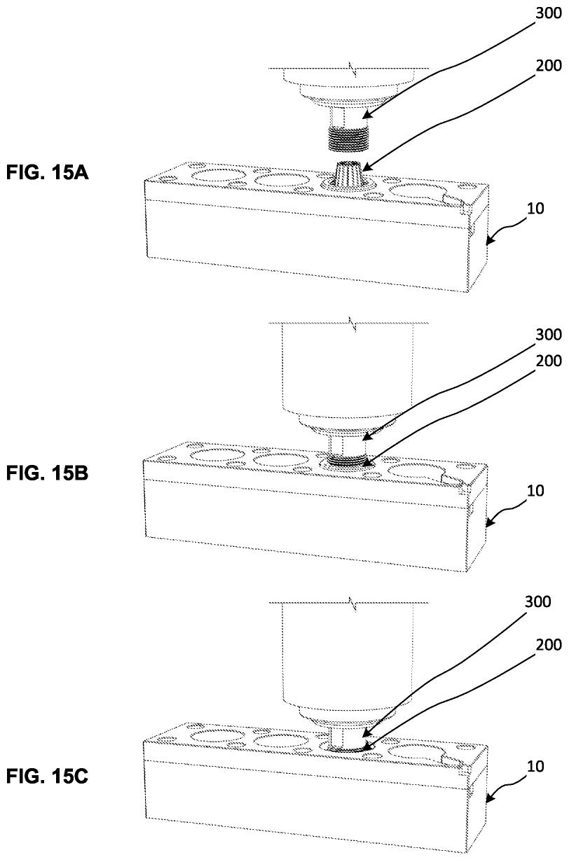

With reference to FIGS. 1A-15, an automatic tool change (ATC) magazine system, also referred to herein as an ATC magazine 10, may be used to facilitate the storing, loading, and unloading of various tools to be used on a standard spindle 300 of a computer numerical control (CNC) machine or similar machine. When a tool is loaded on the spindle 300 of a CNC machine, a user in control of the CNC machine positions the spindle 300 to a desired location so the tool can perform a function. This function may include etching, drilling, milling, grinding, etc., and various tools may perform a specific, or an array, of various functions. The ATC magazine 10 includes a base 12, a spring 14, a rapid change (RC) socket 16, and a retaining cap 18. The base 12 is of a generally rigid material that may comprise of metal or a hard type of polymer of High Density Polyethylene (HDPE) plastic. The base 12 includes an exterior side 20 and an interior side 22 opposite the exterior side 20. Both the exterior side 20 and the interior side 22 may generally be flat, planar surfaces. One or more passageways 24 extend between the exterior side 20 and the interior side 22, each passageway 24 defined by an exterior opening 26 disposed on the exterior side 20 of the base 12, and an interior opening 28 disposed on the interior side 22 of the base. While the example shown in FIG. 1A shows a total of four passageways 24, it can be appreciated that the base 12 may include fewer passageways or more passageways. Each passageway 24 is spaced apart from one another so as to not interfere or overlap with one another while maintaining structural rigidity and manufacturing limitations and logistics of the base 12.

Furthermore, and with reference now to FIGS. 1A-6, the base 12 includes a rapid change (RC) socket shelf 30 and a spring shelf 32 disposed within each passageway 24. The spring shelf 32 is disposed at a position closer to the exterior side 20 of the base 12 compared to the socket shelf 30, whereas the socket shelf 30 is disposed at a position closer to the interior side 22 of the base 12 compared to the spring shelf 32. The spring shelf 32 is generally circular in shape whereas the socket shelf 30 is shaped to correspond to the general shape of the RC socket 16, both the spring shelf 32 and the socket shelf 30 being generally flat, planar surfaces. With the socket shelf 30 and the spring shelf 32 disposed in the passageway 24 of the base 12, the socket shelf 30 and the spring shelf 32 act to reduce the diameter of the passageway 24. In other words, the diameter of the passageway 24 is greatest between the interior opening 28 and the socket shelf 30. The diameter of the passageway 24 is reduced between the socket shelf 30 and the spring shelf 32, and the diameter of the passageway 24 is reduced once again, and is the smallest, between the socket shelf 30 and the exterior opening 26. Additionally, the passageway 24 includes a socket passageway wall 34 that defines the portion of the passageway 24 between the interior opening 28 and the socket shelf 30. The socket passageway wall 34 is shaped to correspond to both the shape of the socket shelf 30 and the shape of the RC socket 16. It is this portion of the passageway 24 between the interior opening 28 and the socket shelf 30 that defines a pocket 35. The pocket 35, while accessible by both the interior opening 28 and the exterior opening 26, utilizes the socket shelf 30 to prevent the RC socket 16 contained within the pocket 35 from dropping through the exterior opening 26, as the socket shelf 30 constricts the exterior opening 26 to a smaller size than the RC socket 16 that may be contained within the pocket 35, which is explained in greater detail below.

Disposed within each passageway 24 is the spring 14. The spring 14 may be of a compression type spring, or a similarly designed spring that comprises the same behavioral properties of a compression spring. The spring 14 includes a proximal end 36 and a distal end 38 opposite the proximal end 36. When disposed in the passageway 24, the distal end 38 is positioned closer to the exterior opening 26 compared to the proximal end 36, whereas the proximal end 36 is positioned closer to the interior opening 28 compared to the distal end 38. The distal end 38 rests on the spring shelf 32, the spring shelf 32 sized to prevent the spring 14 from extending beyond the spring shelf 32 or through the exterior opening 26 of the base 12.

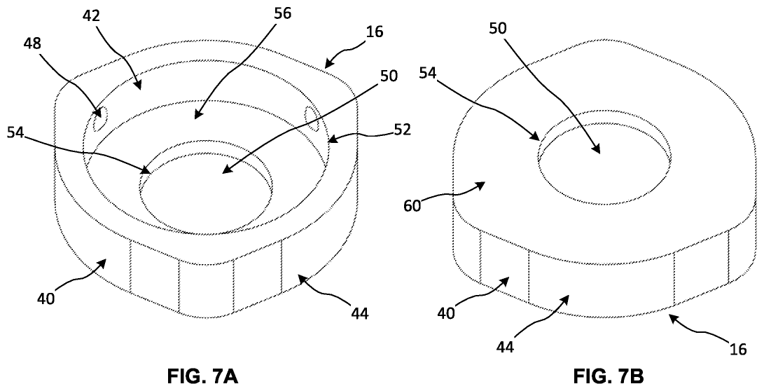

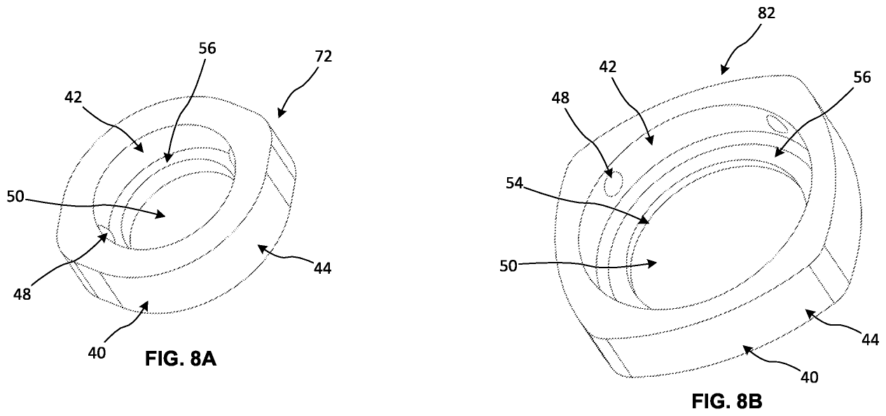

With continued reference to FIG. 1A-7B, also disposed within each passageway 24 is the RC socket 16. Specifically, the RC socket 16 is positioned between the interior opening 28 of the base 12 and the socket shelf 30, the RC socket 16 being confined by the socket passageway wall 34. The RC socket 16 is of a Acrylonitrile Butadiene Styrene (ABS) plastic construction or similar rigid material that comprises an exterior surface 40 and an interior surface 42 opposite the exterior surface 40. The exterior surface 40 is of a multi-sided or non-circular surface, whereas the interior surface 42 is generally circular or rounded. While the example shown in FIG. 7A shows the exterior surface 40 as a rounded triangular-shaped socket 82, it can be appreciated that the exterior surface 40 may be shaped as a square, an octagon, an oval, or any non-circular shape that can be geometrically prevented from spinning or rotating when the RC socket 16 is placed in the corresponding and shape-matching pocket 35. With reference to FIG. 8A, an oval-shaped socket 72 is generally shown, representing an alternate socket design that may be used in the ATC magazine 10 when design modifications are made to match the shape of the oval-shaped socket 72. With reference to FIG. 8B, a rounded square-shaped socket 82 is generally shown, representing an alternate socket design that may be used in the ATC magazine 10 when design modifications are made to match the shape of the four sided spheroid-shaped socket 82. Continuing with the example shown in FIGS. 1A-7B, and with reference to the description above, it is specifically the shape of the exterior surface 40) that must correspond and match the shape of the socket passageway wall 34 within the pocket 35 and correspond and match the shape of the socket shelf 30.

The RC socket 16 also includes a body 44 disposed between the exterior surface 40) and the interior surface 42. Disposed on or partially within the interior surface 42 are two or more contact points or engagement members 48, such as a ball bearing disposed in a cavity, with a portion of each contact point 48 extending beyond the interior surface 42 of the socket. While this example shows a total of three contact points 48 in the form of ball bearings or protrusions, the quantity of engagement members may be less or more, depending on design and shape considerations of the RC socket 16. In some implementations, there are at least two engagement members included with the RC socket 16.

A conduit 50) extends through the body 44 of the RC socket 16 and is defined by a top socket opening 52 and a lower socket opening 54, both the top socket opening 52 and the lower socket opening 54 being generally circular in shape. A portion of the conduit 50 is circumscribed by the interior surface 42 of the RC socket 16. Furthermore, a tool assembly shelf 56 is disposed within the conduit 50 and extends perpendicularly from the interior surface 42 of the RC socket 16. The tool assembly shelf 56 includes an interior side 58 and an exterior side 60 opposite the interior side 58, wherein, when installed in the ATC magazine 10, the exterior side 60 is pressed against the proximal end 36 of the spring 14. The tool assembly shelf 56 circumscribes the remaining portion of the conduit 50 that is not circumscribed by the interior surface 42. Furthermore, due to the tool assembly shelf 56 extending perpendicularly from the interior surface 42 of the RC socket 16, the exterior side 60 of the tool assembly shelf 56 defines the lower socket opening 54. Because of this, the lower socket opening 54 is geometrically smaller than the top socket opening 52.

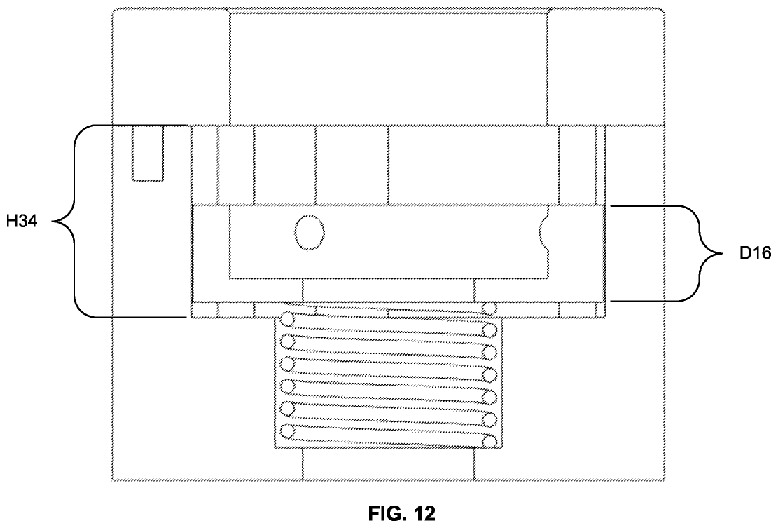

Referring to FIG. 12, the RC socket 16 includes a socket depth D16, the socket depth D16 defined by the distance between the top socket opening 52 and the lower socket opening 54. The socket depth D16 is less than a height H34 of the socket passageway wall 34. The difference between the depth D16 of the RC socket 16 and the height H34 of the socket passageway wall 34 allows the RC socket 16 to move up and down within the passageway 24 while remaining within the confines of the socket passageway wall 34, between the socket shelf 30 and the interior opening 28.

With continued reference to FIGS. 1A-7B, the ATC magazine 10 also includes the retaining cap 18. The retaining cap 18 comprises an upper side 62 and a lower side 64 opposite the upper side 62. The lower side 64 is of a flat and planar surface that is disposed on the interior side 22 of the base 12. The retaining cap 18 is of a generally rigid material that may comprise of metal or a hard type of polymer of High Density Polyethylene (HDPE) plastic. Comprised in the retaining cap 18 is one or more channels 66 extending through and between the upper side 62 and the lower side 64, each of the one or more channels 66 defined by an upper opening 68 and a lower opening 70. The upper opening 68 is disposed on the upper side 62, while the lower opening 70 is disposed on the lower side 64. While the example described herein shows the retaining cap 18 including four channels 66, the retaining cap 18 may include fewer channels or more channels. The quantity of channels 66 corresponds to the quantity of passageways 24 included in the base 12.

The positioning of each channel 66 matches and corresponds to the positioning of each passageway 24. That is, the upper opening 68 is directly centered and above the exterior opening 26 of the base 12. The channel 66, including the upper opening 68 and the lower opening 70, are generally circular and rounded in shape. Furthermore, the size and shape of the lower opening 70 correspond to the size and shape of the top socket opening 52. This sizing prevents the force of the spring 14 from pushing the RC socket 16 into the confines of the channel 66, as the body 44 of the RC socket 16 is sized larger than the lower opening 70 of the retaining cap 18. Thereby, the position of the top socket opening 52 and the lower opening 70 of the retaining cap 18 are located at the same position. As the RC socket 16 cannot extend into the retaining cap 18, the retaining cap 18 keeps the RC socket 16 and the spring 14 in a preloaded state.

In operation, the ATC magazine 10 may facilitate the storing, loading, and unloading of various tool assemblies 200 to be used on a standard spindle 300 of a CNC machine or similar machine. A CNC tool or cutter 202, such as a drill bit, end mill, or any tool that may be used in the standard spindle 300 of a CNC machine, is inserted into a spring collet 204. A threaded clamping nut 206 is installed on the spring collet 204, the clamping nut 206 forcing a tapered outer portion of the spring collet 204 upward into a matching tapered inner portion 304 of the spindle 300, thus compressing the spring collet 204 radially around the tool 202 so as to secure the tool 202 to the spring collet 204. This compression from the spring collet 204 on the tool 202, via the clamping nut 206 and tapered inner portion 304 of the spindle 300, prevents the tool 202 from slipping in the spring collet 204, especially during operation of the CNC machine when forces are applied to the tool 202 as it mills, drills, bores, or performs whatever action or function intended for the specific tool 202. The clamping nut 206 is also the portion of the tool assembly 200 that is threaded onto threads 302 of the spindle 300 of the CNC machine, the tool assembly 200 comprising the clamping nut 206, the spring collet 204, and the tool 202, while the spindle 300 is the component of the CNC machine that moves up, down, side to side, and spins/rotates as desired by the user of the CNC machine, allowing the tool 202 to perform its function. With the tool assembly 200 threaded onto the threads 302 of the spindle 300, the user is able to run a program on the CNC machine and perform the desired tooling function by the vertical, horizontal, and rotational movement of the spindle 300, and thus, the tool 202.

The operation of the ATC magazine 10 includes a method of loading and unloading the tool assembly 200 onto the standard spindle 300 of the CNC machine. With the ATC magazine 10 configured as described above, the exterior side 20 of the base 12 is fixed to the CNC machine bed, or may be attached to a mechanism that moves horizontally along the X or Y axis, planar with the exterior side 20 of the base 12, or a turn table style mechanism, both of which may move the ATC magazine 10 into the correct location for interaction with the spindle 300.

The tool assembly 200 rests in one of the channels 66 of the retaining cap 18 via the upper opening 68. Each upper opening 68 is able to accommodate one tool assembly. The tool/cutter 202 is positioned downward in the ATC magazine 10, whereas the clamping nut 206 is facing upward, the tool/cutter 202 and clamping nut 206 on opposing ends of the tool assembly 200. The entirety of the clamping nut 206 is disposed within the channel 66 of the retaining cap, whereas, depending on the specific tool 202, the tool 202 may extend through the conduit 50 of the RC socket 16 and the passageway 24 of the base 12. Furthermore, when the tool assembly 200 is disposed in the ATC magazine 10, the clamping nut 206 may lightly rest upon the tool shelf 56.

Generally, the clamping nut 206 has an upper portion and a lower portion, the lower portion positioned downward when disposed in the ATC magazine 10. The lower portion is generally hexagonal in shape, whereas the upper portion is a cylindrical shape. The lower portion of the clamping nut 206 is the portion that contacts the engagement member 48 which restricts the clamping nut 206 from rotating, whereas a segment of the upper portion of the clamping nut 206 is generally confined to the channel 66 of the retaining cap 18 while a segment of the lower portion is disposed within the conduit 50 of the RC socket 16 at this specific point in the method.

Continuing with the description of the method, the CNC machine program (also referred to as g code) that is being run to perform this method brings the spindle 300 into a position that is centered directly above the upper opening 68 of the retaining cap 18. Once the spindle 300 is centered, it may be energized for clockwise rotation at, for example, 1500 RPM. The spindle 300 then moves downward towards the ATC magazine 10, eventually engaging the spindle 300 with the clamping nut 206 once it reaches the clamping nut 206. At this point, the clamping nut 206 threads onto the threads 302 of the spindle 300 while a peripheral edge 208 of the clamping nut 206, already being fully engaged with the engagement members 48 of the RC socket 16, holds the clamping nut 206 against rotation, resulting in an abrupt rotational stop of the spindle 300, similar to the operation of an impact wrench. This abrupt rotational stop, accommodated by the torqueing limits of the threads, tightens the clamping nut 206 onto the spindle 300, and the rotating mass of the spindle 300 shaft abruptly stopping applies approximately 12 ft. lbs. of torque to the clamping nut 206.

At this point in the method, the spindle 300 may be raised in tandem with the threaded clamping nut 206 on the spindle 300, the clamping nut 206 tightened on the spindle 300 to 12 ft. lbs. Once the spindle 300 raises to a point where the peripheral edge 208 of the clamping nut 206 is no longer engaged with the engagement members 46 of the RC socket 16, the spindle 300 resumes rotation and may plunge back downward into the pocket 35. The rotating spindle 300 and threaded tool assembly 200, moving downward into the pocket 35, will force the peripheral edge 208 of the clamping nut 206 to once again engage with the engagement members 48 of the RC socket 16. Once engaged, the clamping nut 206 will once again experience an abrupt stop. The rotational mass of the spindle 300, now combined with the rotational mass of the tool assembly 200, applies an additional two to three ft. lbs. of torque to the clamping nut 206 when the clamping nut 206 is abruptly stopped from rotating, further tightening the clamping nut 206 onto the spindle 300 until the spindle 300 stops as well due to the abrupt rotational stop of the clamping nut 206 and the torqueing limits of the threads. This additional two to three ft. lbs. of applied torque, combined with the initial 12 ft. lbs. of applied torque, exceeds the minimum torque value requirements for the spindle 300 to sufficiently hold the threaded clamping nut 206 of the tool assembly 200 so as to allow the tool/cutter 202 to function properly.

While the method described above explains the procedure for loading/installing the tool assembly 200 on the spindle 300, the method for unloading/uninstalling the tool assembly 200 from the spindle 300 entails a similar concept. With the tool assembly 200 threaded to the spindle 300, the spindle 300 is positioned above the ATC magazine 10 and centered directly above the upper opening 68 of the retaining cap 18. The spindle 300 is energized to rotate, counter-clockwise, at a desired speed such as 1500 RPM, which also rotates the attached tool assembly 200. Once this rotational speed is reached, the spindle 300 plunges downward towards the pocket 35. As the spindle 300 moves downward, the peripheral edge 208 of the clamping nut 206 will engage with the engagement members 48, abruptly stopping rotation of the tool assembly 200.

At this point, the spindle 300 will continue to rotate in a counter-clockwise direction as it unthreads the rotationally-fixed clamping nut 206 from the spindle 300. As the clamping nut 206 is unthreaded, the clamping nut 206 will be forced to move downward to provide sufficient space for the threads of the clamping nut 206 to fully unthread from the threads 302 of the spindle 300. This continued downward movement of the clamping nut 206 forces the RC socket 16 further downward in the pocket 35, thus compressing the spring 14. The force applied from the spring 14 to the RC socket 16 as the RC socket 16 moves downward prevents the RC socket 16 from “bottoming out” or engaging with the socket shelf 30 which, if did occur, would prevent the clamping nut 206 from continuing to unthread from the spindle 300. Once the spindle 300 rotates an amount necessary to fully unthread from the clamping nut 206, the spindle 300 will begin moving upward and above the ATC magazine 10. As the spindle 300 moves upward, the spring 14 will partially decompress as it forces the RC socket 16 and tool assembly 200 upward. The RC socket 16 will come to a stop when it engages with the retaining cap 18, preventing the RC socket 16 from moving upward any further.

The tool assembly 200, now uninstalled from the spindle 300, remains disposed in the channel 66, with the freedom to rotate between the engagement members 48, and is stored until once again installed on the spindle 300. Furthermore, due to the small surface are of the engagement members 48 that work to stop the rotation of the clamping nut 206, the clamping nut 206 will not be jammed as a result of the uninstallation process, readying the clamping nut 206 for immediate reinstallation on the spindle 300 if desired. In other words, the user will not be required to unjam or reposition the tool assembly 200 in the ATC assembly 10 to prepare the clamping nut 206 for installation on the spindle 300. If the surface area of the engagement members that interact with the clamping nut 206 were too large, or if the engagement members were removed entirely and the clamping nut 206 could only achieve an abrupt rotational stop from engaging with an interior surface of the RC socket 16 that corresponds to the shape of the clamping nut 206, the user may be required to unjam and reposition the tool assembly 200 after uninstallation to prepare the tool assembly 200 for installation.

The engagement members 48, comprising a spherical shape in the example shown in FIG. 7A-8B, protruding from the interior surface 42 of the RC socket 16 a distance, as an example, of 0.8 mm, provides minimal surface contact between the clamping nut 206 and the engagement members while still inhibiting rotation of the clamping nut 206 when fully engaged. This geometry frees the clamping nut 206 after being uninstalled from the spindle 300 and prevents the clamping nut 206 from jamming in the RC socket 16 during the abrupt stop, coming to rest loosely in the same orientation as it was before the initial installation/loading process.

The above described ATC assembly 10 and corresponding method allows the CNC machine to automatically load/install and unload/uninstall the tool assembly 200 to and from the spindle 300. The ATC assembly 10 is compatible with every size and variety of CNC machine that employs a common spindle as described in the example above which speaks to the versatility of the ATC assembly 10. Furthermore, the simplicity of the ATC assembly 10 allows the automatic loading/installation and unloading/uninstallation process to occur indefinitely with little to no regular maintenance aside from as-needed cleaning.

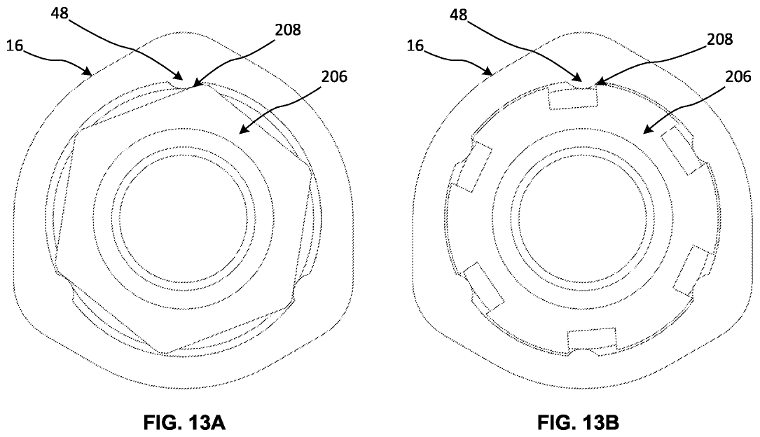

The minimal surface area of the engagement members 48 applied against the clamping nut 206 permits the use of UM-type clamping nuts, wherein, with reference to FIG. 13B. UM-type clamping nuts comprise a circular outer surface with multiple channels disposed on the outer surface, the channels extending from the bottom of the UM-type clamping nut and continuing upwards a short distance before reaching the top of the UM-type clamping nut, the channels arranged at 60, 90 or 180 degree spacing around the outer surface, inhibiting rotation of the clamping nut in the same manner as the method described above.

With continued reference to FIG. 13B, the engagement members 48 are fixed in the RC socket and the RC socket is prevented from rotational movement. The more engagement members that are present in the RC socket, the less force each engagement member receives when struck with the clamping nut 206, spreading the load of the rotating clamping nut 206 across all engagement members. As an example, a CNC machine with an excessively powerful spindle requires less rotational inertia to achieve functional torqueing of the clamping nut 206 on the spindle during the installation process, in which case, a lesser number of engagement members, such as two, would be sufficient to achieve the result of the above-described method. With a clamping nut 206 comprising a lower portion shaped hexagonally with six flat surfaces and six peripheral edges, or a UM-style clamping nut 206 with six channels, there may be two, three, or six engagement members. A variety of clamping nut sizes may be utilized: ER11 2, ER16 3, ER20 3, ER25 3, and ER32 6.

As the RC socket 16 comprises a polymer-type material, impact absorption is sufficient to withstand the impact of the clamping nut 206 during its abrupt stop against the engagement members 48 without resulting in damage to the RC socket. Furthermore, both the geometry of the RC socket 16 and the spherical shape of the engagement members 48 are critical in proper operation of this method to halt the rotation of the clamping nut 206 during the loading and unloading process of the method wherein the clamping nut 206 experiences a sufficient amount of torque applied to the threads 302 of the spindle 300 during the loading process. The channel 35 is shaped to fit the RC socket 16 and prevent the RC socket 16 from rotation. This rotational prevention allows the engagement members 48 to remain non-rotational even when engaged with the fast-rotating clamping nut 206. Furthermore, the small amount of surface area applied from the engagement members 48 to the clamping nut 206 prevent the clamping nut 206 from becoming jammed once the clamping nut 206 and spindle 300 abruptly stop rotating

The ATC magazine 10 may include various accessories and attachments to increase the ease of performing this method. As an example, a system or sensor to detect whether the tool assembly 200 has been removed or returned to the ATC magazine 10 may also be incorporated as an optional feature. Furthermore, a dust cover may be disposed on the upper side 62 of the retaining cap 18 to prevent debris from entering the ATC magazine 10 when not in use. As stated above, the ATC magazine 10 may be used to store tool assemblies, and keeping these tool assemblies, as well as the internals of the ATC magazine 10, free of debris, is important for longevity and ease of uninterrupted operation during tool loading and unloading. The dust cover may also operate automatically, moving aside from the retaining cap 18 once tool loading or unloading is imminent, and returning to the retaining cap 18 once the loading or unloading has completed. The ATC magazine 10 may also include a tool setting probe which would assist in detecting correct tool positioning, detecting if the tool is broken or damaged, among other features.

A number of implementations have been described. Nevertheless, it will be understood that various modifications may be made without departing from the spirit and scope of the disclosure. Accordingly, other implementations are within the scope of the following claims.

The foregoing description has been provided for the purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A rapid change automatic tool change (ATC) magazine comprising:
a base having an exterior side and an interior side opposite the exterior side, and one or more passageways extending between the exterior side and the interior side, each of the one or more passageways defined by an interior opening and an exterior opening;
a spring disposed within each of the one or more passageways of the base, the spring having a distal end facing the exterior opening of each of the one or more passageways, and a proximal end facing the interior opening of each of the one or more passageways;
a socket disposed within each of the one or more passageways, the socket having a body, an exterior surface, and an interior surface opposite the exterior surface with two or more engagement members disposed on the interior surface, wherein the exterior surface circumscribes the interior surface; and
a retaining cap having an upper side and a lower side opposite the upper side, wherein the retaining cap is fixed to the interior side of the base, and wherein the retaining cap includes one or more channels extending through the upper side and the lower side, each of the one or more channels being defined by an upper opening and a lower opening, wherein each of the one or more channels aligns with one of the one or more passageways.

2. The ATC magazine of claim 1, wherein each one or more passageways of the base includes a socket shelf and a spring shelf.

3. The ATC magazine of claim 2, wherein a passageway wall between the interior side of the base and the socket shelf is shaped to correspond to the shape of the exterior surface of the socket.

4. The ATC magazine of claim 2, wherein a height of the passageway wall between the interior side of the base and the socket shelf is greater than a depth of the socket.

5. The ATC magazine of claim 1, wherein the socket includes a conduit, the conduit extending through the body of the socket and is defined by a top socket opening and a lower socket opening, wherein a portion of the conduit is circumscribed by the interior surface of the socket.

6. The ATC magazine of claim 1, wherein the socket includes a tool assembly shelf disposed within the conduit, extending perpendicularly from the interior surface of the socket, the tool assembly shelf comprising an interior side and an exterior side opposite the interior side, the exterior side positioned against the proximal end of the spring.

7. The ATC magazine of claim 6, wherein the tool assembly shelf defines the lower socket opening.

8. The ATC magazine of claim 1, wherein the shape of the interior surface of the socket is generally rounded.

9. The ATC magazine of claim 1, wherein the shape of the exterior surface of the socket is non-rounded.

10. The ATC magazine of claim 1, wherein each channel within the retaining cap is generally rounded.

11. The ATC magazine of claim 1, wherein the shape of the interior surface of the socket is non-hexagonal.

12. A method for installing tools on non-automatic tool change spindles, the method comprising:
providing a rapid change automatic tool change (ATC) magazine;
disposing a tool assembly, within a channel of a retaining cap of the rapid change ATC magazine;
positioning a spindle of a CNC or similar machine above the rapid change ATC magazine, wherein the spindle is centered at an upper opening of the retaining cap;
moving the spindle downward toward a clamping nut of the tool assembly disposed within a socket in the channel;
rotating the spindle in a clockwise direction;
engaging the spindle with the clamping nut, the clamping nut threading onto threads of the rotating spindle with a peripheral edge of the clamping nut engaging with two or more engagement members of the socket that protrude inward;
continuing to rotate the spindle until engagement of the peripheral edge of the clamping nut and the two or more engagement members resists rotation to cause an abrupt rotational stop of the spindle, transmitting a torqueing force through the clamping nut that urges the clamping nut further onto the threads of the spindle; and
moving the spindle upward and away from the ATC magazine with the tool assembly fully threaded onto the spindle.

13. The method of claim 12, wherein the socket includes a body, an exterior surface, and an interior surface opposite the exterior surface with the two or more engagement members disposed on the interior surface, wherein the exterior surface circumscribes the interior surface.

14. The method of claim 13, wherein the shape of the interior surface of the socket is non-hexagonal.

15. The method of claim 12, wherein the two or more engagement members are spherically shaped to prevent the clamping nut from jamming within the socket.

16. A rapid change automatic tool change (ATC) magazine comprising:
a base having an exterior side and an interior side opposite the exterior side, and one or more passageways extending between the exterior side and the interior side, each of the one or more passageways defined by an interior opening and an exterior opening;
a spring disposed within each of the one or more passageways of the base;
a socket disposed within each of the one or more passageways, the socket having a body, an exterior surface, and an interior surface opposite the exterior surface; and
a retaining cap having an upper side and a lower side opposite the upper side wherein the retaining cap includes one or more channels extending through the upper side and the lower side, each of the one or more channels being defined by an upper opening and a lower opening, wherein each of the one or more channels aligns with one of the one or more passageways.

17. The ATC magazine of claim 16, wherein the spring has a distal end facing the exterior opening of each of the one or more passageways and a proximal end facing the interior opening of each of the one or more passageways, wherein the exterior surface of the socket circumscribes the interior surface, wherein two or more engagement member are disposed on the interior surface, and wherein the retaining cap is fixed to the interior side of the base.

18. The ATC magazine of claim 17, wherein the two or more engagement members are spherically shaped to prevent the clamping nut from jamming within the socket.

19. The ATC magazine of claim 17, wherein a height of the passageway wall between the interior side of the base and a socket shelf is greater than a depth of the socket.

20. The ATC magazine of claim 16, wherein the shape of the interior surface of the socket is non-hexagonal.
